(19) United States
(12) Patent Application Publication
(10) Pub. No.: US 2022/0055473 A1
(43) Pub. Date: Feb. 24, 2022

(54) Hybrid Powertrain for a Motor Vehicle, and Method for Operating a Hybrid Powertrain

(71) Applicant: ZF Friedrichshafen AG, Friedrichshafen (DE)

(72) Inventors: Stefan Beck, Eriskirch (DE); Fabian Kutter, Kressbronn (DE); Matthias Horn, Tettnang (DE); Thomas Martin, Weissensberg (DE); Michael Wechs, Weißensberg (DE); Johannes Kaltenbach, Friedrichshafen (DE); Martin Brehmer, Tettnang (DE); Peter Ziemer, Tettnang (DE); Thomas Kroh, Lindau (DE); Oliver Bayer, Hörbranz (AT); Max Bachmann, Friedrichshafen (DE)

(21) Appl. No.: 17/432,714

(22) PCT Filed: Oct. 15, 2019
(86) PCT No.: PCT/EP2019/077868

§ 371 Date: Aug. 20, 2021

(30) Foreign Application Priority Data
Mar. 5, 2019 (DE) 10 2019 202 966.3

(51) Int. Cl. B60K 6/547; B60W 10/02; B60W 20/20; B60W 20/40; B60W 10/06; B60W 10/08; B60W 10/113; B60K 6/387; B60K 6/44; F16H 3/091; F16H 3/00; F16H 61/688

(52) U.S. Cl. CPC B60K 6/547; B60W 10/02; B60W 20/20; B60W 20/40; B60W 10/06; B60W 10/08; B60K 2006/4825; B60K 6/387; B60K 6/44; F16H 3/091; F16H 3/006; F16H 61/688; B60Y 2200/92; B60W 10/113

(57) ABSTRACT

A hybrid drive train (10) for a motor vehicle, includes a dual clutch assembly (14) with a first clutch (K1) and a second clutch (K2) having a shared input element (EG) connectable to an internal combustion engine (12). The first clutch (K1) includes a first output element (AG1), and the second clutch (K2) includes a second output element (AG2). A transmission arrangement (16) includes a first sub-transmission (32) and a second sub-transmission (34). An input shaft (24) of the first sub-transmission (32) is connected to the first output element (AG1), and an input shaft (26) of the second sub-transmission (34) is connected to the second output element (AG2). The dual clutch assembly (14) also includes a third clutch (K3) for connecting the first sub-transmission (32) and the second sub-transmission (34), a first electric machine (56) connected to the first input shaft (24), a second electric machine (60) connected to the second input shaft (26), and a control device (22) for actuating the dual clutch assembly (14), the transmission arrangement (16), the third clutch (K3), and the first electric machine (56) and the second electric machine (60).

### CROSS-REFERENCE TO RELATED APPLICATIONS

The present application is related and has right of priority to German Patent Application No. 102019202966.3 filed in the German Patent Office on Mar. 5, 2019 and is a nationalization of PCT/EP2019/077868 filed in the European Patent Office on Oct. 15, 2019, both of which are incorporated by reference in their entirety for all purposes.

### FIELD OF THE INVENTION

The present invention relates generally to a hybrid drive train for a motor vehicle, with a dual clutch assembly, which includes a first clutch and a second clutch, which include a shared input element connectable to an internal combustion engine, wherein the first clutch includes a first output element and wherein the second clutch includes a second output element, with a transmission arrangement, which has a first sub-transmission and a second sub-transmission, wherein an input shaft of the first sub-transmission is connected to the first output element and wherein an input shaft of the second sub-transmission is connected to the second output element, with an electric machine and with a control device.

The present invention further relates generally to a method for operating a hybrid drive train of this type.

### BACKGROUND

A transmission arrangement of the above-described type is known from document DE 10 2006 036 758 A1. The automated dual clutch transmission disclosed therein includes two input shafts and at least one output shaft and an unsynchronized gear clutch, wherein associated with each of the input shafts is a separate engine clutch for connection to the drive shaft of a prime mover and, for connection to the output shaft, a group of gear-step gearwheels, in each case, having different ratios and each including one fixed gear and one idler gear engageable by an associated gear clutch. In order to simplify the configuration and the controllability, the two engine clutches are designed as unsynchronized dog clutches. Two electric machines, which are alternately drivingly connected to one of the input shafts, are provided as starting and synchronizing means.

Dual clutch transmissions have represented an alternative to torque converter automatic transmissions for several years. Dual clutch transmissions have a dual clutch assembly, which is connectable on the input side to a prime mover such as an internal combustion engine. An output element of a first friction clutch of the clutch assembly is connected to a first input shaft of a first sub-transmission, which is typically associated with the even forward gear steps or with the odd forward gear steps. An output element of a second friction clutch of the dual clutch assembly is connected to a second input shaft of a second sub-transmission, which is typically associated with the other forward gear steps.

The gear steps associated with the sub-transmissions can generally be engaged and disengaged in an automated manner. During normal operation, one of the clutches of the dual clutch assembly is engaged. In the other, inactive, sub-transmission, a connecting gear step can then be engaged in advance. A gear change can then be carried out essentially without interruption of tractive force by an overlapping actuation of the two friction clutches.

Motor vehicle transmissions are generally designed either for the front or the rear transverse installation in a motor vehicle, wherein attention is paid, in particular, to a short axial installation length. Alternatively, transmissions are designed for a longitudinal installation in a motor vehicle, wherein attention is paid, in particular, to a radially compact design.

In the front and rear transverse transmissions, two countershafts arranged axially parallel are frequently associated with an input shaft arrangement, and so the power flow can take place from the input shaft arrangement either via the one countershaft or via the other countershaft. The countershafts are also designed as output shafts and, in general, are both in engagement with a differential for distributing input power to driven wheels.

A further trend in the field of motor vehicle drive trains is hybridization. In general, this means a prime mover in the form of an internal combustion engine has associated therewith an electric machine, as a further prime mover. Here, a distinction is made between a plurality of different concepts, which each provide a different connection of the electric machine to the transmission. In a typical variant of dual clutch transmissions, an electric machine is arranged concentrically to an input element of the dual clutch assembly. In order to be able to utilize the electric machine, in this case, not only for assisting the internal combustion engine, but rather also to be able to set up a purely electric motor-driven operation, the input element of the dual clutch assembly is generally connected to the internal combustion engine by a separating clutch or an internal combustion engine-decoupling device.

The hybridization of transmissions, with respect to the requirements mentioned at the outset, places high requirements on radial and/or axial installation space.

In the dual clutch transmission described in DE 10 2006 036 758 A1 mentioned at the outset, an electric machine is associated with each sub-transmission. Moreover, the dual clutch assembly is formed by two unsynchronized dog clutches. The rotational-speed adaptations necessary for the starting operation and for the synchronization during gear changes are implemented by the electric machines. The unsynchronized dog clutches are combined in a shared clutch block, which has two engagement positions, in which one of the two clutches is engaged in each case, and a neutral position with a completely interrupted power flow. During gear changes in an internal combustion engine-driven operation, a changeover of the clutches of the dual clutch assembly is always necessary. Moreover, depending on the type of the gear change, one or both electric machine(s) must be actuated for the synchronization and/or for the load transfer. Moreover, during these types of gear changes, the internal combustion engine must always self-synchronize.

### SUMMARY OF THE INVENTION

Example aspects of the present invention provide an improved hybrid drive train for a motor vehicle and improved methods for operating a hybrid drive train of this type.

Example aspects of the present invention provide, on the one hand, a hybrid drive train for a motor vehicle, with a dual clutch assembly, which includes a first clutch and a second clutch. The first and second clutches include a shared input element connectable to an internal combustion engine. The first clutch includes a first output element, and the second clutch includes a second output element. The hybrid drive train also includes a transmission arrangement, which has a first sub-transmission and a second sub-transmission. An input shaft of the first sub-transmission is connected to the first output element, and an input shaft of the second sub-transmission is connected to the second output element. The hybrid drive train further includes a third clutch for connecting the first sub-transmission and the second sub-transmission, a first electric machine connected to the first input shaft, a second electric machine connected to the second input shaft, and a control device for actuating the dual clutch assembly, the transmission arrangement, the third clutch, and the first electric machine and the second electric machine.

Moreover, example aspects of the present invention provide a method for operating a hybrid drive train of the type according to example aspects of the invention. The method includes, during an internal combustion engine-driven operation or a hybrid operation, utilizing the gear steps of the one sub-transmission by engaging the associated clutch of the dual clutch assembly and utilizing the gear steps of the other sub-transmission by engaging the same clutch and the third clutch.

Moreover, example aspects of the present invention provide a method for operating a hybrid drive train of the type according to example aspects of the invention. The method includes, in an internal combustion engine-driven operation, disengaging the third clutch in a gear step of the one sub-transmission, in order to decouple the other sub-transmission and the electric machine associated with the other sub-transmission.

Moreover, example aspects of the present invention provide a method for operating a hybrid drive train of the type according to example aspects the invention. The method includes, in a purely electric motor-driven operation, providing input power of the first electric machine via the first sub-transmission and simultaneously providing input power of the second electric machine via the second sub-transmission, wherein a powershift is implemented, in that one of the electric machines maintains the tractive force via the associated sub-transmission, while a gear change is carried out in the other sub-transmission.

The hybrid drive train according to example aspects of the invention makes it possible, due to the provision of the third clutch for connecting the first sub-transmission and the second sub-transmission, for gear changes to be carried out in an internal combustion engine-driven operation or in a hybrid operation without the need to actuate the dual clutch assembly. Moreover, since a separate electric machine is associated with each sub-transmission, both electric machines can be provided for making input power available.

In addition, both electric machines can be utilized as a generator or as a motor in a serial operation. In the present case, a serial operation is understood to mean that, in a purely electric motor-driven operation by one of the two electric machines, the other electric machine is simultaneously driven by the internal combustion engine and operated as a generator, in order to charge a vehicle battery. The vehicle battery is preferably the same battery from which the electric machine operating as a motor draws power.

In addition, with the hybrid drive train according to example aspects of the invention, it is possible to utilize an electric machine for synchronization during gear changes in an internal combustion engine-driven operation or a hybrid operation, i.e., to assist the internal combustion engine during synchronization with an electric machine. In other words, in the internal combustion engine-driven operation or in the hybrid operation, one of the electric machines is always connected to the internal combustion engine. As a result, a load-point displacement at the internal combustion engine is possible and this electric machine can assist during the closed-loop control of the rotational speed when a shift element, such as a gearshift clutch, must be synchronized. Consequently, the internal combustion engine does not need to synchronize “on its own”, but rather is always “picked up” at the current rotational speed of the internal combustion engine by one of the two electric machines.

In the internal combustion engine-driven operation or in the hybrid operation, upon implementation of one example embodiment of a method according to example aspects of the invention, the one clutch of the one sub-transmission remains engaged for all conditions of this operation, while the other clutch of the dual clutch assembly always remains disengaged during all conditions of this operation.

In a purely electric motor-driven operation, it is possible with the hybrid drive train according to example aspects of the invention to disengage both clutches of the dual clutch assembly and to engage the third clutch, and so the two electric machines are coupled to each other and, jointly, can provide input power via a single gear step. Alternatively, it is possible, in a purely electric motor-driven operation, to operate the two electric machines in parallel via the respective particular sub-transmissions and to leave the third clutch disengaged.

The second clutch of the dual clutch assembly, which is preferably always disengaged in the normal internal combustion engine-driven operation and in the normal hybrid operation, is preferably engaged during the serial operation. In the serial operation, one electric machine operates as a motor and provides electric motor-generated power for a purely electric motor-driven operation, for example, for an operation in a starting gear step (first gear), in order to drive a vehicle in a “crawler gear”. In a crawler gear of this type, the ground speed of the vehicle is generally below a speed, at which the internal combustion engine can be utilized as a prime mover (due to the ratio of the lowest gear step or starting gear step). In order to also be able to permanently establish a low ground speed of this type beyond the maximum capacity of the vehicle battery, the above-described serial operation can be implemented.

In the transmission arrangement, the first input shaft and the second input shaft are preferably arranged coaxially to each other. The first input shaft is preferably designed as an inner shaft. The second input shaft is preferably designed as a hollow shaft. The transmission arrangement preferably includes precisely one countershaft. Preferably, the one countershaft is simultaneously an output shaft of the transmission arrangement. For this purpose, the countershaft is preferably connected to an output gear, which is designed for driving a power distribution arrangement, such as a differential.

Engageable gear sets are understood to be, in the present case, gear sets that include an idler gear and a fixed gear, which are in engagement with each other in an intermeshed manner, and which are engageable by an associated gearshift clutch. In an engaged gear set, the idler gear of this gear set is rotationally fixed to the associated shaft. The gear sets are preferably spur gear trains, which preferably connect one of the two input shafts and the countershaft to each other, in each case.

Associated with each gear set, preferably, is a regular forward gear step, i.e., a fixed ratio. The transmission arrangement preferably does not include a gear set, with which a reverse gear step is associated. Travel in reverse is preferably implemented exclusively via one of the electric machines.

The third clutch preferably connects the first input shaft and the second input shaft. The third clutch is preferably not a clutch of the type that is utilized for establishing a winding-path gear step in the transmission arrangement. This is the case because, during the establishment of a winding-path gear step, two gear sets of each of the two sub-transmissions are generally involved, in order to implement a ratio that is as low as possible or a ratio that is as high as possible, i.e., in order to allow for a high spread of gear ratios of the transmission arrangement. In the present case, however, power is preferably always transmitted only via one gear set either from the first input shaft to the countershaft or from the second input shaft to the countershaft, and so the spread of gear ratios of the transmission arrangement results preferably exclusively due to the ratios of the regular forward gear steps. Consequently, the transmission arrangement can generally operate with a high efficiency.

In one preferred example embodiment, the first sub-transmission is associated with the odd gear steps. In a corresponding way, the second sub-transmission in one preferred example embodiment is associated with the even forward gear steps.

In the present case, a connection is understood to mean, in particular, that the two elements to be connected to each other are permanently connected to each other in a rotationally fixed manner. Alternatively or as necessary, the two elements can be connected to each other in a rotationally fixed manner. In the present case, a rotationally fixed connection is understood to mean that the elements connected in with the rotationally fixed matter rotate at a rotational speed proportional to each other.

The electric machines are preferably arranged axially parallel to the transmission arrangement. Consequently, the longitudinal axes of the electric machines are preferably arranged in parallel, although offset with respect to the input shafts as well as to the countershaft.

In a preferred example variant, the order of the elements starting from an input of the transmission arrangement is as follows: Gear set for the fourth forward gear step 4; gearshift clutch assembly for the fourth and second forward gear steps 4 and 2; gear set for the second forward gear step 2; gearshift clutch assembly with the third clutch and a gearshift clutch for the third forward gear step 3 (or the fifth forward gear step 5), gear set for the third forward gear step 3 (or the fifth forward gear step 5), gear set for the first forward gear step 1, gearshift clutch assembly for the first and third forward gear steps 1 and 3 (or the first and fifth forward gear steps 1 and 5), and gear set for the third forward gear step 3 (or the fifth forward gear step 5).

The gearshift clutch assemblies for the second and fourth forward gear steps 2 and 4 as well as for the first and third forward gear steps 1 and 3 (or the first and fifth forward gear steps 1 and 5) are preferably arranged at a countershaft. A gearshift clutch assembly, which contains the third clutch and a gearshift clutch for the fifth or third forward gear step 5 or 3, is preferably arranged coaxially to the input shafts.

According to one preferred example embodiment, the control device is configured for establishing at least the following operating modes:
a purely internal combustion engine-driven operation;
a purely electric operation by the first electric machine; and
a purely electric operation by the second electric machine.

Moreover, the control device is configured for establishing a hybrid operation, in which input power is provided by the internal combustion engine and electric motor-generated input power is provided by the first electric machine and/or the second electric machine. The hybrid traveling mode can be a drive mode, although the hybrid travelling mode can also be a mode, in which mechanical input power is at least partially supplied to the electric machines, in order to operate the electric machines as generators for charging a vehicle battery.

Moreover, the hybrid drive train is preferably configured for carrying out a sailing operation, in which, starting from a moderate or high ground speed, the internal combustion engine is decoupled and the ground speed is maintained, for example, by an intermittent operation of one or both electric machine(s). Stationary charging is also possible.

As mentioned, a crawling mode is also possible, in particular for the case in which a serial operation is established, as defined above. Consequently, the hybrid drive train is operable in all conceivable electric motor-driven, internal combustion engine-driven, or hybrid traveling modes.

According to one preferred example embodiment, the third clutch and a gearshift clutch for engaging a gear set of a sub-transmission are accommodated in a gearshift clutch assembly.

In general, a gearshift clutch assembly is understood to be an arrangement of two gearshift clutches, which are alternatively actuatable by one single actuating unit. Moreover, a gearshift clutch assembly generally has a neutral position, in which neither of the two gearshift clutches of the assembly is engaged. A gearshift clutch assembly of this type can also be referred to as a double shift element.

It is particularly preferred when the gear set that is engageable by the gearshift clutch assembly is associated with the sub-transmission, the associated clutch of which is always engaged in the internal combustion engine-driven operation and in the hybrid operation. Preferably, the gear set that is engageable by the gearshift clutch assembly is associated with the first sub-transmission, which is associated with the odd forward gear steps. It is particularly preferred when the gear set is associated with the fifth forward gear step 5 or the third forward gear step 3.

According to one further preferred example embodiment, the first clutch of the dual clutch assembly and/or the second clutch of the dual clutch assembly and/or the third clutch and/or at least one gearshift clutch of the transmission arrangement are/is designed as a dog clutch, i.e., as an unsynchronized shift element. A dog clutch of this type includes, in particular, no friction elements for synchronizing components to be connected to each other.

Due to the fact that a separate electric machine is associated with each sub-transmission, functions of the synchronization and/or of the load transfer can take place via the electric machines. Accordingly, the above-mentioned clutches can be designed as dog clutches, and so potential for the reduction of the axial and/or radial installation space can result, as well as weight advantages.

The two clutches of the dual clutch assembly can be actuated independently of each other by separate actuating units. It is particularly preferred, however, when the first clutch and the second clutch of the dual clutch assembly are accommodated in a gearshift clutch assembly, which is actuated by a single actuating unit. Consequently, the gearshift clutch assembly has a first position, in which the first clutch is engaged, a second position, in which the second clutch is engaged, and a third position, in which neither the first clutch nor the second clutch is engaged, i.e., a neutral position.

In a further example embodiment preferred overall, the first electric machine is connected to the first input shaft via a gear-step gear set of the first sub-transmission and/or the second electric machine is connected to the second input shaft via a gear-step gear set of the second sub-transmission.

In general, it is conceivable to arrange the electric machines coaxially to, for example, the particular input shaft of the sub-transmissions. It is preferred, however, that the electric machines are arranged axially parallel to the input shaft arrangement. The connection to the particular input shaft can then take place via a flexible traction drive mechanism or a gear set. A separate gear set can be provided for this purpose. This can have the advantage of a connection having an optimized ratio. As mentioned above, it is preferred, however, when the connection of the electric machines takes place via particular gear-step gear sets. Weight can be saved as a result. A ratio adaptation can preferably take place in that a machine pinion of the particular electric machine is not directly connected to a gearwheel of the gear-step gear set or is in engagement therewith in an intermeshed manner, but rather that an intermediate gear is intermediately connected, and so the electric machines can be connected to the particular sub-transmissions with an optimized ratio. In particular, the electric machines can be implemented as relatively high-speed machines, which, consequently, can be designed to be compact.

It is particularly preferred when the gear-step gear set of the first sub-transmission, via which the first electric machine is connected to the first input shaft, is associated with the highest gear step of the first sub-transmission, and/or when the gear-step gear set of the second sub-transmission, via which the second electric machine is connected to the second input shaft, is associated with the highest gear step of the second sub-transmission.

According to one further preferred example embodiment, the gear-step gear set of the first sub-transmission, via which the first electric machine is connected to the first input shaft, is arranged at a first axial end of the transmission arrangement, and/or the gear-step gear set of the second sub-transmission, via which the second electric machine is connected to the second input shaft, is arranged at a second axial end of the transmission arrangement.

This allows for a connection of the electric machine, on the one hand, at the points, at which high bearing forces can be absorbed, since housing walls or bearing plates are generally arranged at the axial ends of the transmission arrangement. Moreover, this allows for a connection of the electric machines in such a way that these connections remain as unaffected as possible from each other. In addition, this type of connection makes it possible for the electric machines to be arranged in axial overlap with each other. It is particularly preferred when the first electric machine and/or the second electric machine extend(s) between the first axial end of the transmission arrangement and the second axial end of the transmission arrangement. As a result, an axially compact design can also be implemented.

According to one further example embodiment preferred overall, the first sub-transmission is associated with the odd forward gear steps and includes three gear sets, which are associated with different forward gear steps, and/or the second sub-transmission is preferably associated with the even forward gear steps and includes two or three gear sets, which are associated with different forward gear steps.

Via five or six forward gear steps, an internal combustion engine-driven operation across a large speed range can be implemented. For very low speed ranges, travel can take place exclusively by electric motor, if necessary.

The transmission arrangement therefore preferably has only five or six gear set planes. Moreover, the transmission arrangement preferably has only three gearshift clutch planes, in each of which preferably precisely one gearshift clutch assembly is arranged.

Preferably, the transmission arrangement includes only precisely four actuating units, three of which are associated with the gearshift clutch assemblies of the transmission arrangement and one of which is associated with the dual clutch assembly.

According to one further example embodiment preferred overall, the first electric machine and the second electric machine are identical.

This yields cost advantages and stock-control advantages. The two electric machines can then operate practically “equally” within the transmission arrangement and can both be operated alternatively as a prime mover for driving a motor vehicle and/or as a generator for charging a vehicle battery.

Overall, by the hybrid drive train, depending on the example embodiment, at least one of the following advantages is achieved:
low design complexity, since preferably only five (if necessary, six) gear set pairs and four actuating units are to be provided;
good efficiency and a simple configuration result, since, in particular, no winding-path gear steps are implemented;
low component loads result;
at least three electric gear steps result for the first electric machine and at least two gear steps result for the second electric machine;
the transmission arrangement includes preferably only one countershaft, which is preferably connected to a power distribution unit via only one output gear set;
gear change operations can be carried out quickly and efficiently, since an engagement of the dual clutch assembly is not necessary in an internal combustion engine-driven operation and a hybrid operation and since the synchronization of gear steps is always implementable also by utilizing an electric machine;
a serial operation is implementable by the first electric machine and also by the second electric machine as a generator;
this yields high versatility in combination with compact dimensions.

It is particularly preferred when an internal combustion engine-driven operation and a hybrid operation are established in such a way that one of the two clutches of the dual clutch assembly is always engaged and the other clutch always remains disengaged (depending on the gear step, the third clutch is disengaged or engaged).

In order to also be able to disengage, under load, the clutch of the dual clutch assembly that is always engaged in this case, for example, in the case of an emergency brake application, it can be preferable to implement this clutch of the dual clutch assembly as a normally disengaged friction clutch. The other clutch, which always remains disengaged in this operation, can still be implemented as a dog clutch.

It is understood that the features, which are mentioned above and which will be described in greater detail in the following, are usable not only in the particular combination indicated, but also in other combinations or alone, without departing from the scope of the present invention.

### BRIEF DESCRIPTION OF THE DRAWINGS

Exemplary embodiments of the invention are represented in the drawings and are explained in greater detail in the following description, wherein

FIG. 1 shows a diagrammatic gear set representation of an example embodiment of a hybrid drive train;

FIG. 2 shows a diagrammatic power flow representation of a further example embodiment of a hybrid drive train;

FIG. 3 shows a schematic of a further example embodiment of a hybrid drive train;

FIG. 4 shows an alternative example embodiment of a dual clutch assembly;

FIG. 5 shows a gearshift table for an internal combustion engine-driven operation and a hybrid operation of the example hybrid drive train from FIG. 1;

FIG. 6 shows a gearshift table for an electric motor-driven operation by the first electric machine; and

FIG. 7 shows a gearshift table for an electric motor-driven operation by the second electric machine.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

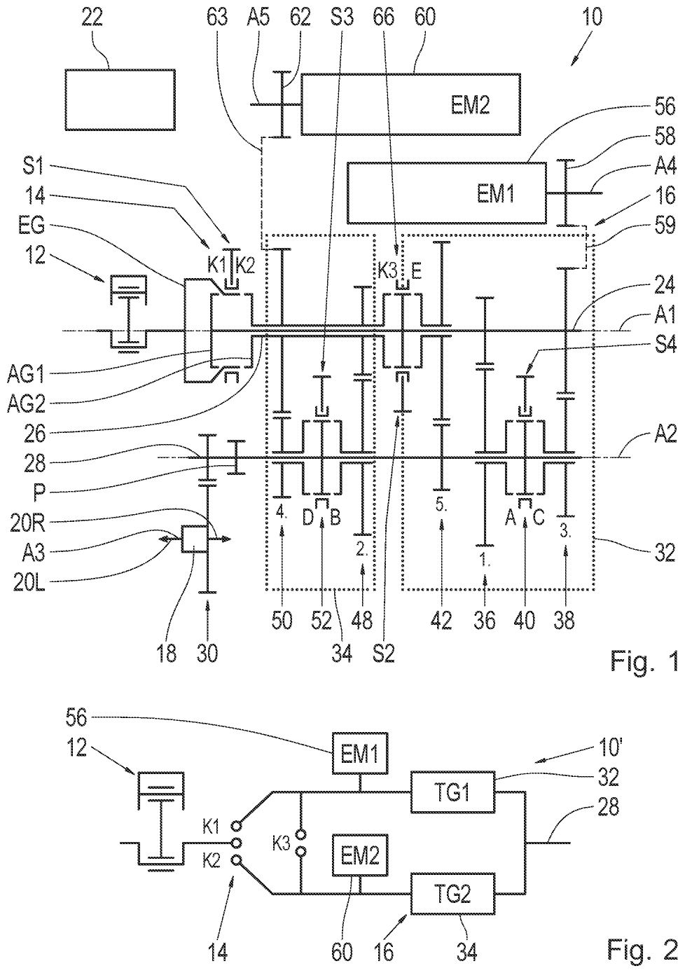

In FIG. 1, a hybrid drive train for a motor vehicle, in particular a passenger car, is represented in diagrammatic form and is labeled, in general, with 10.

The hybrid drive train 10 includes an internal combustion engine 12, which is connected to an input element of a dual clutch assembly 14. The dual clutch assembly 14 is connected on the output side to a hybrid transmission arrangement 16. An output of the hybrid transmission arrangement 16 is connected to a power distribution unit 18, which can be designed, for example, as a mechanical differential and can distribute the input power to two driven wheels 20L, 20R of the motor vehicle.

Moreover, the hybrid drive train 10 contains a control device 22 for controlling all components thereof.

The dual clutch assembly 14 is arranged on an axis A1, which is coaxial to a crankshaft of the internal combustion engine 12. The dual clutch assembly 14 can include two friction clutches or one friction clutch and an unsynchronized dog clutch. In the present case, the dual clutch assembly 14 contains two unsynchronized dog clutches K1 and K2. The two clutches K1, K2 have a shared input element EG, which is rotationally fixed to the crankshaft of the internal combustion engine 12. The first clutch K1 has a first output element AG1. The second clutch K2 has a second output element AG2. The output elements AG1, AG2 are arranged coaxially to each other.

The transmission arrangement 16 includes a first input shaft 24 and a second input shaft 26. The input shafts 24, 26 are arranged coaxially to each other and to the axis A1. The first input shaft 24 is designed as an inner shaft. The second input shaft 26 is designed as a hollow shaft.

Moreover, the transmission arrangement 16 contains a countershaft 28, which is designed as an output shaft 28 and is arranged coaxially to a second axis A2. The output shaft 28 is connected via an output gear set 30 to the power distribution unit 18, which is arranged coaxially to an axis A3.

A parking interlock gear can be fixed at the output shaft 28 or at an input element of the power distribution unit 18 in a rotationally fixed manner, by which the hybrid drive train 10 can be immobilized. The associated parking lock device is not represented, for the sake of clarity.

The transmission arrangement 16 has a first sub-transmission 32 and a second sub-transmission 34. The sub-transmissions 32, 34 are arranged axially offset with respect to each other. The first sub-transmission 32 is arranged adjacent to a first axial end of the transmission arrangement 16. The second sub-transmission 34 is arranged adjacent to a second axial end of the transmission arrangement 16, wherein the second axial end is adjacent to the dual clutch assembly 14. The sub-transmissions 32, 34 have a plurality of engageable gear sets, which, in the engaged condition, connect an input shaft and the output shaft 28 in each case.

The first sub-transmission 32 has a first gear set 36 for the first forward gear step 1 and a second gear set 38 for the third forward gear step 3. The second gear set 38 is arranged closer to the first axial end of the transmission arrangement 16 than the first gear set 36. A first gearshift clutch assembly 40 is arranged between the first gear set 36 and the second gear set 38 and, in fact, coaxially to the axis A2. The first gearshift clutch assembly 40 includes a first gearshift clutch A for engaging the first gear set 36 and a second gearshift clutch C for engaging the second gear set 38. The two gearshift clutches A, C are alternatively engageable and are designed as unsynchronized dog clutches. The engagement of a gear set includes the rotationally fixed connection of an idler gear of the particular gear set to an associated shaft. In the present case, for example, the first gear set 36 is engaged, in that an idler gear of the first gear set 36, which is rotatably mounted at the output shaft 28, is rotationally fixed to the output shaft 28, in order to bring the first gear set 36 into the power flow in this way.

Moreover, the first sub-transmission 32 has a third gear set 42 for the forward gear step 5. The third gear set 42 is arranged closer to the second axial end of the transmission arrangement 16 than the first gear set 36.

The third gear set 42 is engageable by a gearshift clutch E and has an idler gear, which is rotatably mounted at the first input shaft 24.

The second sub-transmission 34 has a fourth gear set 48 for the second forward gear step 2 and a fifth gear set 50 for the fourth forward gear step 4. The fifth gear set 50 is arranged closer to the second axial end than the fourth gear set 48. A second gearshift clutch assembly 52 is arranged between the gear sets 48, 50 and, in fact, coaxially to the axis A2. The second gearshift clutch assembly 52 has a gearshift clutch B for engaging the fourth gear set 48 and a gearshift clutch D for engaging the fifth gear set 50. The gearshift clutches B and D are accommodated in the second gearshift clutch assembly 52 in such a way that the gearshift clutches B and D are alternatively actuatable.

Consequently, the transmission arrangement 16 has five gear set planes, namely, starting from the second axial end toward the first axial end, in the following order: gear set 50 for the fourth forward gear step 4; gear set 48 for the second forward gear step 2; gear set 42 for the fifth forward gear step 5; gear set 36 for the first forward gear step 1; and gear set 38 for the third forward gear step 3.

Moreover, the hybrid drive train 10 includes a first electric machine 56, which is arranged coaxially to a fourth axis A4. The first electric machine 56 has a first pinion 58, which is rotationally fixed to a rotor of the first electric machine 56 and is coaxial to the axis A4. The first pinion, which can also be referred to as the first machine pinion, is connected to a gear-step gear set of the first sub-transmission 32, in the present case to the second gear set 38 for the third forward gear step 3, via a first intermediate gear 59, which is rotatably mounted at an axle (not described in greater detail). More precisely, the first pinion 58 meshes with the first intermediate gear 59, and the first intermediate gear 59 meshes with a fixed gear of the second gear set 38, wherein the fixed gear is rotationally fixed to the first input shaft 24.

Moreover, the hybrid drive train 10 has a second electric machine 60, which is arranged axially parallel to the input shafts 24, 26 and, in fact, coaxially to a fifth axis A5. The second electric machine has a second pinion (second machine pinion) 62, which is arranged coaxially to the axis A5. The second pinion 62 is connected to the second input shaft 26 via a gear-step gear set of the second sub-transmission 34. In the present case, the second pinion 62 is connected to the fifth gear set for the fourth forward gear step 4 via a second intermediate gear 63. More precisely, the second pinion 62 meshes with the second intermediate gear 63, which is rotatably mounted at an axle (not described in greater detail), and the second intermediate gear 63 meshes with a fixed gear of the fifth gear set 50, wherein the fixed gear is rotationally fixed to the second input shaft 26.

The five axes A1, A2, A3, A4, A5 are all aligned in parallel with one another.

The dual clutch assembly 14 is arranged adjacent to the second axial end of the transmission arrangement 16, as mentioned above. The output gear set 30 is also arranged on the second axial side of the transmission arrangement 16 and is preferably axially aligned with the dual clutch assembly 14 or is situated approximately in a plane therewith. The parking interlock gear P can be fixed at the output shaft 28 between the output gear set 30 and the fifth gear set 50.

In the hybrid drive train 10, the electric machines 56, 60 are each connected to a gear-step gear set of the associated sub-transmission, which is associated with the highest gear step of that sub-transmission. Moreover, the electric machines 56, 60 are each connected via a gear-step gear set to the associated particular sub-transmission, which is preferably arranged adjacent to an axial end of the transmission arrangement. The gear sets are situated at opposite axial ends.

The electric machines 56, 60 are arranged in axial overlap with each other. Due to the connection via intermediate gears 59, 63, high ratios with respect to the particular gear-step gear sets can be established, and so relatively high-speed electric machines can be utilized, which are compact.

The hybrid transmission arrangement in the present example embodiment has precisely five forward gear steps and does not have a reverse gear step. An operation in reverse can be exclusively established by the hybrid drive train 10 when one of the electric machines 56 or 60 is driven in the opposite direction of rotation.

The transmission arrangement 16 has no winding-path gear steps. Each gear set 36 through 50 includes precisely one idler gear and one fixed gear, wherein the idler gears of the gear sets 36, 38, 48, 50 are rotatably mounted at the output shaft 28, and wherein the idler gear of the gear set 42 is rotatably mounted at the first input shaft 24.

Moreover, the hybrid drive train 10 includes a third clutch K3, which can also be referred to as a bridge clutch.

The third clutch is utilized for connecting the first input shaft 24 and the second input shaft 26. The third clutch K3 is arranged adjacent to the fourth gear set 48 for the second forward gear step 2 and is accommodated, with the gearshift clutch E for the third gear set 42 for engaging the fifth forward gear step 5, in a third gearshift clutch assembly 66. The third clutch K3, just like the gearshift clutches A, B, C, D, E, is implemented as an unsynchronized dog clutch.

The third gearshift clutch assembly 66 is arranged coaxially to the first axis A1 and, in fact, between the gear sets 42, 48.

The dual clutch assembly 14 and the three gearshift clutch assemblies 40, 52, 66 are actuatable by four actuating units S1 through S4.

One actuating unit S1 is utilized for actuating the dual clutch assembly 14 and can either engage the clutch K1, or engage the clutch K2, or establish a neutral position.

In a corresponding way, the first gearshift clutch assembly 40 can be actuated by a fourth actuating unit S4. By the fourth actuating unit S4, either the gearshift clutch A can be engaged, or the gearshift clutch C can be engaged, or a neutral position can be established.

In a corresponding way, the second gearshift clutch assembly 52 can be actuated by a third actuating unit S3, in order to either engage the clutch D, or engage the clutch B, or establish a neutral position.

Finally, the third gearshift clutch assembly 66 can be engaged by a second actuating unit S2, in order to either engage the clutch K3, or engage the clutch E, or establish a neutral position.

In FIG. 2, a further example embodiment of a hybrid drive train 10′ is represented, which generally corresponds to the drive train 10 from FIG. 1 with respect to the configuration and the mode of operation. Identical elements are therefore indicated by identical reference characters.

It is apparent that input power from the internal combustion engine can be guided either via the clutch K1 to the first sub-transmission 32 or via the clutch K2 to the second sub-transmission 34. Input power of the first electric machine 56 can be supplied directly into the first sub-transmission 32 or, via the clutch K1, toward the internal combustion engine 12 (for example, in order to start the internal combustion engine 12).

Input power of the second electric machine 60 can be introduced directly into the second sub-transmission 34 or, via the clutch K2, to the internal combustion engine 12, for example, in order to start the internal combustion engine 12.

Moreover, it is apparent that the first sub-transmission 32 and the second sub-transmission 34 are connectable to each other via a third clutch K3, and so, for example, when the clutch K1 is engaged, internal combustion engine-generated power can flow via the clutch K3 to the second sub-transmission 34.

In this case, the first electric machine 56 can be switched to idle, and so the first electric machine 56 rotates in a nearly loss-free manner, or can be operated as a generator or as an electric motor.

In a corresponding way, when the clutch K2 is engaged, power of the internal combustion engine 12 can be directed to the first sub-transmission 32 when the clutch K3 is engaged.

Moreover, a serial operation is possible when, for example, purely electric motor-generated input power from the first electric machine 56 is guided via the first sub-transmission 32 to the output shaft 28. In this case, with the first and third clutches K1 and K3 disengaged, the clutch K2 can be engaged, in order to utilize input power of the internal combustion engine 12 to drive the second electric machine 60, in order to allow the second electric machine 60 to operate as a generator, which charges a battery (not represented in greater detail) of the drive train 10′. It is understood that all gearshift clutches of the second sub-transmission 34 are disengaged in this case.

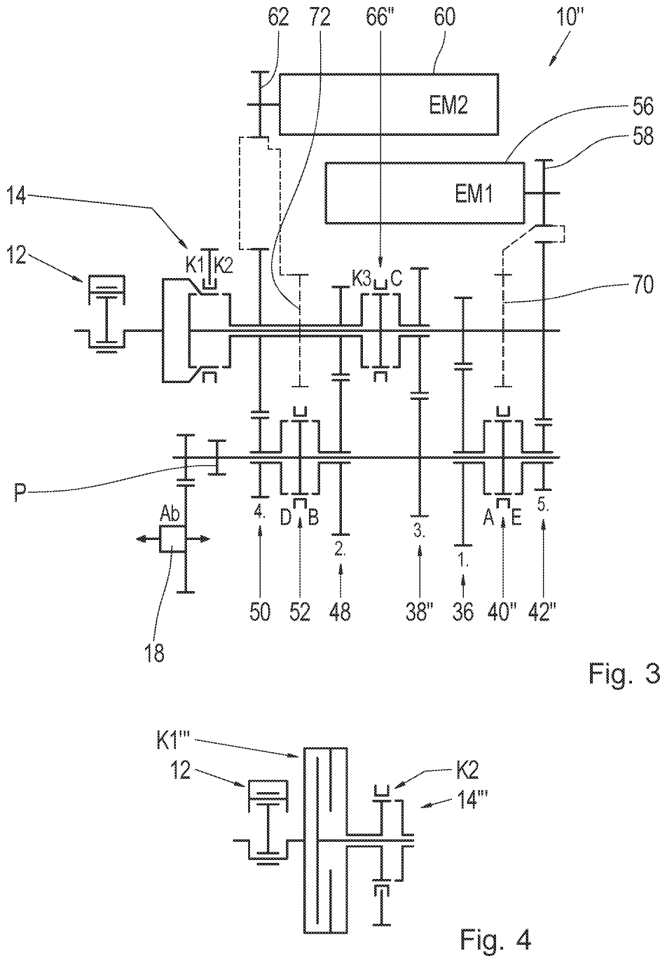

In FIG. 3, a further example embodiment of a hybrid drive train 10″ is represented, which generally corresponds to the drive train 10 from FIG. 1 with respect to configuration and mode of operation. Identical elements are therefore characterized by identical reference characters. In the following, essentially, the differences are explained.

It is apparent, on the one hand, that the gear sets for the third and fifth forward gear steps 3 and 5 are interchanged in the first sub-transmission 32. Consequently, the second gear set 38″ for the third forward gear step 3 is arranged closer to the second axial end of the transmission arrangement 16 than the third gear set 42″ for the fifth forward gear step 5, which is arranged adjacent to the first axial end of the transmission arrangement 16. Correspondingly, the third gearshift clutch assembly 66″ includes the third clutch K3 and the gearshift clutch C for engaging the second gear set 38″ for the third forward gear step 3.

Moreover, the first gearshift clutch assembly 40″ includes the gearshift clutch A for engaging the first gear set 36 for the first forward gear step 1 and the gearshift clutch E for engaging the third gear set 42″ for the fifth forward gear step 5.

As represented in FIG. 3, moreover, the first electric machine 56 and/or the second electric machine 60 do/does not necessarily need to be connected via a gear-step gear set to the particular associated input shaft 24, 26. Rather, it is also possible to fix a first gearwheel (first machine gearwheel) 70 at the first output shaft 24, which is in engagement with the first pinion 58 directly or via a first intermediate gear 59″.

In a corresponding way, a second gearwheel (second machine gearwheel) 72 can be fixed at the second output shaft 26, which is in engagement with the second pinion 62 directly or via a second intermediate gear 63′″.

Due to the first gearwheel 70 and/or the second gearwheel 72, one additional degree of freedom can be implemented, which simplifies the implementation of the pre-ratio.

The first gearwheel 70 is preferably situated in a plane with the first gearshift clutch assembly 40″, and so this implementation is possible in a length-neutral manner. In the same way, the second gearwheel 72 is axially aligned with the second gearshift clutch assembly 52, and so the provision of the second gearwheel 72 also does not result in a lengthening of the installation space.

In particular for the case in which the gearwheels 70, 72 are not provided, but rather a connection is to take place via the gear sets that are arranged at the axial ends of the transmission arrangement 16, the following advantage can be achieved. This is the case because the first electric machine 56 can be connected to the first input shaft 24 via the gear-step gear set 42″ that represents the highest ratio of the first sub-transmission 32, and so a larger ratio can be implemented in the electric operation.

The latter-described example variant is considered to be particularly preferred.

In FIG. 4, an alternative example embodiment of a dual clutch assembly 14′″ is shown, which can be utilized in each of the above-described example drive trains alternatively to the dual clutch assemblies 14 utilized there.

The dual clutch assembly 14′″ includes a second clutch K2, which, similarly to the dual clutch assembly 14, is designed as an unsynchronized dog clutch and which is actuatable by an actuating unit S1.

Instead of the unsynchronized dog clutch K1, a clutch K1′″ is provided in the dual clutch assembly 14′″ in the form of a normally disengaged friction clutch, which is actuatable either by the same actuating unit S1 or by a separate actuating unit S1a and, in fact, independently of the actuating unit S1.

The design of the first clutch K1′″ as a normally disengaged friction clutch can have the advantage that the first clutch K1′″ can also be disengaged under load, for example, in the case of an emergency brake application. As a result, the internal combustion engine can also be decoupled in an emergency of this type.

The second clutch K2 is not utilized in this case (as will also be explained in the following) for establishing a power flow for forward gear steps of the transmission arrangement 16, but rather essentially for coupling the second electric machine 60 to the internal combustion engine 12.

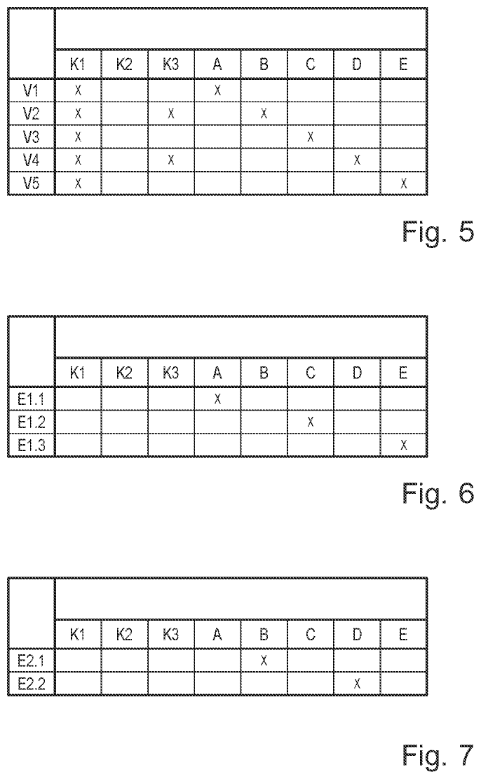

Different operations, which are establishable with the example hybrid drive train 10 from FIGS. 1 and 2, are explained with reference to FIGS. 5 through 7. The same operations are also usable, however, with the example hybrid drive train 10″ from FIG. 3 and/or in connection with the example dual clutch assembly 14′″ from FIG. 4.

FIG. 5 shows a gearshift table of the shift elements K1, K2, K3, A-E in a purely internal combustion engine-driven operation or in a hybrid operation, in which input power is made available by the internal combustion engine and, optionally, by the electric motors.

In all forward gear steps V1 through V5 establishable in this operation, the first clutch K1 is continuously engaged and the second clutch K2 of the dual clutch assembly 14 is continuously disengaged. In the forward gear step V1, the gearshift clutch A is engaged and all other gearshift clutches B through E are disengaged. The third clutch K3 is also disengaged. Consequently, power flows from the internal combustion engine via the first clutch K1 and the first input shaft 24 to the first gear set 36 and, from there, via the gearshift clutch A to the output shaft 28.

It is understood that a driving start from a standstill generally takes place purely by electric motors 56, 60 until a speed is reached, at which the internal combustion engine 12 can be connected via the first clutch K1, i.e., at a speed that corresponds to a rotational speed above the idling speed of the internal combustion engine 12. Consequently, a driving start from a standstill takes place, for example, via the first electric machine 56 and the first gear set 36 for the forward gear step V1. As soon as a speed has been reached that corresponds to the speed of the internal combustion engine 12, the first clutch K1 can be engaged. The first clutch K1 remains engaged during the entire internal combustion engine-driven operation.

During the changeover from the forward gear step V1 into the forward gear step V2, initially the gearshift clutch B for the forward gear step V2 is preliminarily engaged. This can take place, if necessary, with the aid of a synchronization by the second electric machine 60.

Thereafter, the gearshift clutch A for the forward gear step V1 is disengaged, wherein the tractive force is supported by the second electric machine 60 and the already engaged gear set 48 for the forward gear step V2. Thereafter, the third clutch K3 can be engaged, wherein the synchronization necessary therefor takes place, on the one hand, by a rotational-speed adaptation of the internal combustion engine 12, but also by appropriate synchronization measures of the second electric machine 16. In the second forward gear step V2, power therefore flows from the internal combustion engine 12 via the first clutch K1, the first input shaft 24, the engaged third clutch K3, the second input shaft 26, and the gear set 48 for the second forward gear step V2, which is engaged by the gearshift clutch B, to the output shaft 28.

During the changeover into the forward gear step V3, the third clutch K3 is disengaged, the tractive force is supported via the second electric machine 60 and, thereafter, the forward gear step V3 can be engaged in the first sub-transmission 32 by engaging the gearshift clutch C. The necessary synchronization can take place by the first electric machine 56.

Thereafter, the load can be assumed by the first electric machine 56 and the gearshift clutch B of the forward gear step V2 can be disengaged.

The further gear changes from the forward gear steps V3 and V4 and from the forward gear steps V4 and V5 result in a corresponding way. In each of the even forward gear steps V2 and V4, the third gearshift clutch K3 is engaged. The second clutch K2 is always disengaged and the first clutch K1 is always engaged.

In FIG. 6, a purely electric motor-driven operation by the first electric machine is represented. In a first electric gear step E1.1, only the gearshift clutch A for the forward gear step 1 is engaged. In a second electric forward gear step E1.2, only the gearshift clutch C is engaged. In a third electric-motor gear step E1.3, the gearshift clutch E is engaged.

In a corresponding way, FIG. 7 shows a purely electric motor-driven operation by the second electric machine 60. In a first gear step E2.1, only the gearshift clutch B is engaged. In a second electric gear step E2.2, only the gearshift clutch D is engaged.

In the purely electric operation according to FIGS. 6 and 7, purely electric powershifts (i.e., gear changes between forward gear steps without or with reduced interruption of tractive force) are possible. Here, an electric motor-driven operation is established exclusively, for example, between the gear steps E1.1, E1.2, E1.3 or exclusively between the gear steps E2.1 and E2.2, and a gear change takes place while the other electric machine maintains the tractive force.

During a gear change, for example, from the forward gear step E1.1 into the forward gear step E1.2, the gearshift clutch B can be engaged in the second sub-transmission 34 and, consequently, the second electric machine 60 can maintain the tractive force during the gear change in the first sub-transmission 32.

In the purely internal combustion engine-driven operation or hybrid operation (i.e., for the case in which internal combustion engine-generated power and, optionally, electric motor-generated power are guided to the output shaft), it is advantageous that the third clutch K3 is utilized for connecting the second input shaft 26 to the first input shaft 24 and, consequently, always supplying internal combustion engine-generated power into the transmission arrangement 16 via the first input shaft 24. Consequently, the first electric machine 56 associated with the first sub-transmission 32 is always rotationally fixed to the internal combustion engine 12 during this operation. As a result, it is possible to establish load-point displacements at the internal combustion engine 12 and the first electric machine 56 can provide assistance during the closed-loop control of the rotational speed when a synchronization process is to take place. In other words, since the first clutch K1 always remains engaged, the first electric machine 56 can assist the internal combustion engine 12 during synchronization.

In order to integrate the third clutch K3, which is necessary therefor, into the transmission arrangement as efficiently as possible, the third clutch K3 is accommodated in the third gearshift clutch assembly 66. Since the third clutch K3 is therefore integrated with a gearshift clutch into a gearshift clutch assembly that is associated with that sub-transmission, the associated clutch K1—of the dual clutch assembly 14—of which is always engaged in the internal combustion engine-driven or hybrid operation, the internal combustion engine 12 can utilize all gear steps of the transmission.

The second clutch K2 is engaged, however, when a serial operation is established. Here, the first clutch K1 is disengaged. Via the first sub-transmission 32 and the first electric machine 56, a purely electric motor-driven operation is established in a gear step, for example, in the first forward gear step 1. The internal combustion engine 12 drives the second electric machine 60 via the engaged second clutch K2 and drives the second electric machine 60 as a generator, and so the power withdrawn from a vehicle battery by the first electric machine 56 in this purely electric operation can be simultaneously resupplied, at least partially, via the second electric machine 60.

A serial operation of this type is also possible in reverse when travel takes place purely electrically by means of the second electric machine 60 and the internal combustion engine 12 drives the first electric machine 56. In the latter case, the first clutch K1 is engaged and the second clutch K2 is disengaged.

The serial operation is utilized, in particular, in a crawling mode, in which the vehicle speed is lower than a minimum speed that is establishable by the internal combustion engine 12.

The sub-transmission 32 that is associated with the clutch K1, which is always engaged in the internal combustion engine-driven mode, preferably also includes the highest forward gear step of the transmission arrangement 16. As a result, when the third clutch K3 is disengaged, the second electric machine 60 can be practically decoupled, in order to avoid drag losses. In addition, the first electric machine 56 can remain coupled, in order to supply the main power circuit with electrical energy (operation as a generator), or in order to establish a boost operation (operation as a motor).

During a gear shift from a forward gear step of the first sub-transmission 32 into a forward gear step of the second sub-transmission 34, the desired gear step is initially engaged in the second sub-transmission by engaging the associated gearshift clutch (D or B). This takes place with the aid of a synchronization by the second electric machine 60, wherein the second electric machine 60 switches over, in a load-free manner, into this target gear step in the second sub-transmission 34. Thereafter, the second electric machine 60 supports the tractive force during the gear shift via the already engaged target gear step. During the gear shift, initially the gearshift clutch of the first sub-transmission 32, which is associated with the starting or source gear step, disengages and, thereafter, the third clutch K3 is engaged, wherein the internal combustion engine 12 and the first electric machine 56 interact during the synchronization.

During a gear shift from the second sub-transmission 34 into a gear step of the first sub-transmission 32, the second electric machine 60 initially supports the tractive force in the source gear step or the actual gear during the gear shift. During the gear shift, the third clutch K3 is initially disengaged and one of the shift elements A, C, E engages, wherein the internal combustion engine 12 and the first electric machine 56 interact during the necessary synchronization. After the disengagement of the third clutch K3 and the load transfer on the first sub-transmission 32, the output gear step (actual gear step) in the second sub-transmission 34 is disengaged.

It is understood that a stationary charging can also take place with the hybrid drive train when the vehicle is at a standstill. For example, the first clutch K1 can be engaged and input power of the internal combustion engine 12 is supplied via the first input shaft 24 into the first electric machine 56. The second clutch K2 remains disengaged and also the gearshift clutches A, C, E of the first sub-transmission 32 remain disengaged. Therefore, the first sub-transmission 32 remains in neutral. In this condition, as mentioned, either a stationary charging can take place or a start of the internal combustion engine 12 by the first electric machine 56 can also take place.

In general, it is also conceivable to engage both clutches K1 and K2 or to engage the first clutch K1 and the third clutch K3, in order to allow a charging process to take place by the first electric machine 56 and also by the second electric machine 60. In this case, the internal combustion engine 12 drives both electric machines 56, 60, and both electric machines 56, 60 operate as generators, in order to charge a vehicle battery.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 hybrid drive train
12 internal combustion engine
14 dual clutch assembly
16 hybrid transmission arrangement
18 power distribution unit
20 driven wheels
22 control device
24 first input shaft
26 second input shaft
28 output shaft
30 output gear set
32 first sub-transmission
34 second sub-transmission
36 1st gear set (1)
38 2nd gear set (3)
40 first gearshift clutch assembly
42 3rd gear set (5)
48 4th gear set (2)
50 5th gear set (4)
52 second gearshift clutch assembly
56 first electric machine
58 first pinion (first machine pinion)
59 first intermediate gear
60 second electric machine
62 second pinion (second machine pinion)
63 second intermediate gear
66 third gearshift clutch assembly
70 first gearwheel (first machine gearwheel)
72 second gearwheel (second machine gearwheel)
A1-A5 axes
A-E gearshift clutches for gear steps
K1, K2 clutches of dual clutch assembly
EG Eingangsglied
AG1 first output element
AG2 second output element
K3 third clutch
S1-S4 actuating units
P parking interlock gear

1-14. (canceled)

15. A hybrid drive train (10) for a motor vehicle, comprising:
a dual clutch assembly (14) with a first clutch (K1) and a second clutch (K2), the first and second clutches (K1, K2) comprising a shared input element (EG) connectable to an internal combustion engine (12), the first clutch (K1) comprising a first output element (AG1), the second clutch (K2) comprising a second output element (AG2),
a transmission arrangement (16) with a first sub-transmission (32) and a second sub-transmission (34), an input shaft (24) of the first sub-transmission (32) connected to the first output element (AG1), an input shaft (26) of the second sub-transmission (34) connected to the second output element (AG2);
a third clutch (K3) configured for connecting the first sub-transmission (32) and the second sub-transmission (34);
a first electric machine (56) connected to the first input shaft (24);
a second electric machine (60) drivingly connected to the second input shaft (26); and
a control device (22) in operative communication with the dual clutch assembly (14), the transmission arrangement (16), the third clutch (K3), the first electric machine (56), and the second electric machine (60).

16. The hybrid drive train of claim 15, wherein the control device (22) is configured for establishing one or more of the following operating modes:
a purely internal combustion engine-driven operation;
a purely electric operation by the first electric machine; and
a purely electric operation by the second electric machine.

17. The hybrid drive train of claim 15, wherein the third clutch (K3) and a gearshift clutch (E; C) for engaging a gear set (42; 38″) of one of the first and second sub-transmissions (32, 34) are accommodated in a gearshift clutch assembly (66; 66″).

18. The hybrid drive train of claim 15, wherein one or more of the first clutch (K1), the second clutch (K2), the third clutch (K3), and a gearshift clutch (A, B, C, D, E) of the transmission arrangement (16) is a dog clutch.

19. The hybrid drive train of claim 15, wherein one or both of:
the first electric machine (56) is connected to the first input shaft (24) via a gear-step gear set (38; 42″) of the first sub-transmission (32); and
the second electric machine (60) is connected to the second input shaft (26) via a gear-step gear set (50) of the second sub-transmission (34).

20. The hybrid drive train of claim 19, wherein one or both of:
the gear-step gear set (42″) of the first sub-transmission (32) is associated with a highest gear step (5) of the first sub-transmission (32); and
the gear-step gear set (50) of the second sub-transmission (34) is associated with a highest gear step (4) of the second sub-transmission (34).

21. The hybrid drive train of claim 19, wherein one or both of:
the gear-step gear set (38; 42″) of the first sub-transmission (32) is arranged at a first axial end of the transmission arrangement (16); and
the gear-step gear set (50) of the second sub-transmission (34) is arranged at a second axial end of the transmission arrangement (16).

22. The hybrid drive train of claim 15, wherein one or both of:
the first sub-transmission (32) is associated with odd forward gear steps and has three gear sets (36, 38, 42), each of which is associated a respective odd forward gear step; and
the second sub-transmission (34) is associated with even forward gear steps and has two or three gear sets (48, 50), each of which is associated with a respective even forward gear step.

23. The hybrid drive train of claim 15, wherein the first electric machine (56) and the second electric machine (60) are identical.

24. A method for operating the hybrid drive train of claim 15, comprising, in an internal combustion engine-driven operation or a hybrid operation:
utilizing gear steps (1, 3, 5) of the first sub-transmission (32) by engaging the first clutch (K1); and
utilizing gear steps (2, 4) of the second sub-transmission (34) by engaging the first clutch (K1) and the third clutch (K3).

25. The method of claim 24, wherein a gear change from an initial gear step of the second sub-transmission (34) into a target gear step of the first sub-transmission (32) comprises:
supporting a tractive force within the second electric machine (60);
disengaging the third clutch (K3); and
at least partially synchronizing the target gear step with the first electric machine (56).

26. The method of claim 24, wherein a gear change from an initial gear step of the first sub-transmission (32) into a target gear step of the second sub-transmission (34) comprises:
engaging the target gear step in the second sub-transmission (34), the second electric machine (60) at least partially synchronizing the target gear step during the engagement of the target gear step;
supporting a tractive force within the second electric machine (60);
disengaging the initial gear step; and
engaging the third clutch (K3), the first electric machine (56) at least partially synchronizing the third clutch (K3) during the engagement of the third clutch (K3).

27. A method for operating the hybrid drive train of claim 15, comprising, in an internal combustion engine-driven operation:
disengaging the third clutch (K3) in a gear step of the first sub-transmission (32) in order to decouple the second sub-transmission (34) and the second electric machine (60) associated with the second sub-transmission (34).

28. A method for operating the hybrid drive train of claim 15, comprising, in a purely electric motor-driven operation:
providing input power of the first electric machine (56) via the first sub-transmission (32) and simultaneously providing input power of the second electric machine (60) via the second sub-transmission (34),
wherein, while a gear change is carried out in the second sub-transmission, a powershift is implemented, and
wherein one or both of the first electric machine (56) maintains tractive force via the first sub-transmission (32) and the second electric machine (60) maintains tractive force via the second sub-transmission (34) when the powershift is implemented.
